(19) United States
(12) Patent Application Publication
(10) Pub. No.: US 2018/0229410 A1
(43) Pub. Date: Aug. 16, 2018

(54) ELECTRONIC DEVICE AND METHOD OF MANUFACTURING THE SAME

(71) Applicant: KYOCERA CORPORATION, Kyoto (JP)

(72) Inventor: Katsumi ARAO, Yokohama-shi, Kanagawa (JP)

(21) Appl. No.: 15/753,145

(22) PCT Filed: Aug. 12, 2016
(86) PCT No.: PCT/JP2016/073766

§ 371 Date: Feb. 15, 2018

(30) Foreign Application Priority Data
Aug. 20, 2015 (JP) 2015-162992

(51) Int. Cl. B29C 45/16; B29C 45/40

(52) U.S. Cl. CPC B29C 45/16; B29L 2031/3481; B29C 45/401

(57) ABSTRACT

An electronic device includes a molded component including a first surface. The molded component includes a first portion formed of a first resin material and a second portion formed of a second resin material, the second portion including an exposure region in the first surface as at least a part thereof being embedded in the first portion. The molded component includes a first line in the first surface. At least a part of the first line passes through the inside of the exposure region.

### TECHNICAL FIELD

An embodiment of the present disclosure relates to an electronic device and a method of manufacturing the same.

### BACKGROUND ART

One exemplary technique relating to a gas evacuation trace which is produced in molding of a housing of a portable terminal device with a mold has been known.

### SUMMARY OF INVENTION

The present disclosure desirably provides an electronic device which achieves an improved appearance and a method of manufacturing the same.

An electronic device based on the present disclosure includes a molded component including a first surface. The molded component includes a first portion formed of a first resin material and a second portion formed of a second resin material, the second portion including an exposure region in the first surface as at least a part of the second portion being embedded in the first portion. The molded component includes a first line in the first surface. At least a part of the first line passes through the inside of the exposure region.

### BRIEF DESCRIPTION OF DRAWINGS

FIG. 1 is a first perspective view of an electronic device in a first embodiment based on the present disclosure.

FIG. 2 is a second perspective view of the electronic device in the first embodiment based on the present disclosure.

FIG. 3 is a perspective view of the electronic device with a lid portion being slightly opened in the first embodiment based on the present disclosure.

FIG. 4 is a plan view of the electronic device with the lid portion and a battery having been removed in the first embodiment based on the present disclosure.

FIG. 5 is an exploded view of a rear case member included in the electronic device in the first embodiment based on the present disclosure.

FIG. 6 is a partially enlarged view of an outer member which forms a part of the rear case member included in the electronic device in the first embodiment based on the present disclosure.

FIG. 7 is a cross-sectional view along the line VII-VII in FIG. 6.

FIG. 8 is a plan view of the vicinity of an extension portion exposure region of the outer member included in the electronic device in the first embodiment based on the present disclosure when viewed from a side of a first surface.

FIG. 9 is a flowchart of a method of manufacturing an electronic device in a second embodiment based on the present disclosure.

FIG. 10 is an illustrative diagram of a first step in the method of manufacturing an electronic device in the second embodiment based on the present disclosure.

FIG. 11 is an illustrative diagram of a second step in the method of manufacturing an electronic device in the second embodiment based on the present disclosure.

FIG. 12 is an illustrative diagram of a third step in the method of manufacturing an electronic device in the second embodiment based on the present disclosure.

FIG. 13 is an illustrative diagram of a fourth step in the method of manufacturing an electronic device in the second embodiment based on the present disclosure.

FIG. 14 is an illustrative diagram of a fifth step in the method of manufacturing an electronic device in the second embodiment based on the present disclosure.

FIG. 15 is a partially enlarged view of a first end portion of the outer member included in the electronic device associated with the first and second embodiments based on the present disclosure.

FIG. 16 is a partially enlarged view of a second end portion of the outer member included in the electronic device associated with the first and second embodiments based on the present disclosure.

FIG. 17 is a diagram showing a first example of overlapping between an extension portion exposure region and a first geometric shape.

FIG. 18 is a diagram showing a second example of overlapping between an extension portion exposure region and a first geometric shape.

FIG. 19 is a diagram showing a third example of overlapping between an extension portion exposure region and a first geometric shape.

FIG. 20 is a diagram showing a fourth example of overlapping between an extension portion exposure region and a first geometric shape.

FIG. 21 is a diagram showing a fifth example of overlapping between an extension portion exposure region and a first geometric shape.

FIG. 22 is a diagram showing a sixth example of overlapping between an extension portion exposure region and a first geometric shape.

FIG. 23 is a diagram showing a seventh example of overlapping between an extension portion exposure region and a first geometric shape.

FIG. 24 is a diagram showing an eighth example of overlapping between an extension portion exposure region and a first geometric shape.

FIG. 25 is a diagram showing a ninth example of overlapping between an extension portion exposure region and a first geometric shape.

FIG. 26 is a perspective view of one example of a construction in which an ejector pin is located as being surrounded by a core mold.

FIG. 27 is a cross-sectional view of one example of a construction in which a simple pin is located as being surrounded by a core mold.

FIG. 28 is a perspective view of one example of a construction in which a simple pin is located as being surrounded by a core mold.

FIG. 29 is a perspective view of one example of a construction in which a block in a form of a quadrangular prism is located as being surrounded by a core mold.

FIG. 30 is a cross-sectional view of one example of a construction in which a plurality of members are located as being surrounded by a core mold.

FIG. 31 is a perspective view of another example of a construction in which a plurality of members are located as being surrounded by a core mold.

FIG. 32 is a diagram showing the ninth example of overlapping between an extension portion exposure region and a first geometric shape.

FIG. 33 is a diagram showing a tenth example of overlapping between an extension portion exposure region and a first geometric shape.

FIG. 34 is a diagram showing an eleventh example of overlapping between an extension portion exposure region and a first geometric shape.

FIG. 35 is a perspective view of a first example in which a boundary line is present in a core mold.

FIG. 36 is a diagram showing a twelfth example of overlapping between an extension portion exposure region and a first geometric shape.

FIG. 37 is a diagram showing a thirteenth example of overlapping between an extension portion exposure region and a first geometric shape.

FIG. 38 is a perspective view of a second example in which a boundary line is present in a core mold.

### DESCRIPTION OF EMBODIMENTS

### First Embodiment

An electronic device in a first embodiment based on the present disclosure will be described with reference to FIGS. 1 to 8. FIG. 1 shows an appearance of an electronic device 101 in the first embodiment. Though description of electronic device 101 is given here with a portable telephone being defined as the electronic device by way of example, electronic device 101 is not limited to the portable telephone. Various types of equipment may be assumed as electronic device 101.

As shown in FIG. 1, electronic device 101 includes a display area 31 on a front surface side. Electronic device 101 includes a case member 20. Case member 20 includes a rear case member 21 and a front case member 22.

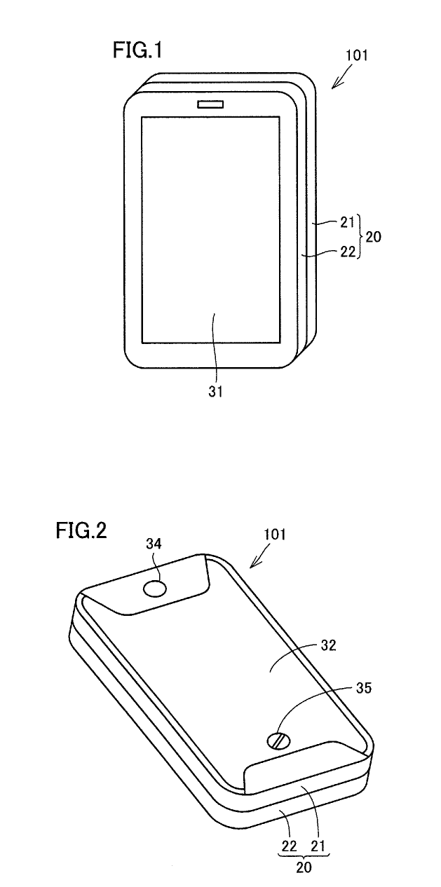

FIG. 2 shows a perspective view in which electronic device 101 is positioned with the rear surface side thereof being mainly seen. For example, an image pick-up portion 34 may be located at one end portion on the rear surface side. A lid portion 32 is combined with rear case member 21. Lid portion 32 is a lid which covers a battery accommodated in electronic device 101. Lid portion 32 may include a screw 35. Screw 35 serves to determine whether to fix lid portion 32. An outer shape of lid portion 32 shown here is merely by way of example and the outer shape is not limited as such.

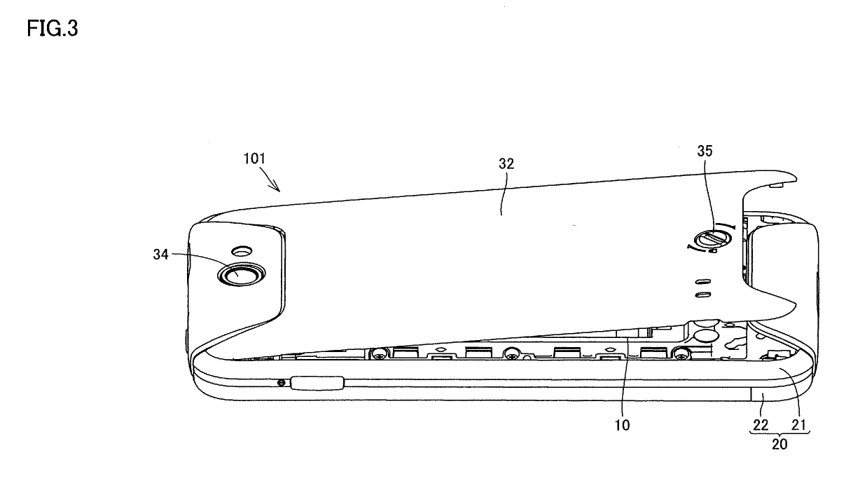

FIG. 3 shows lid portion 32 slightly being opened. By loosening screw 35, tightening of lid portion 32 is loosened so that one end of lid portion 32 can be lifted as shown in FIG. 3.

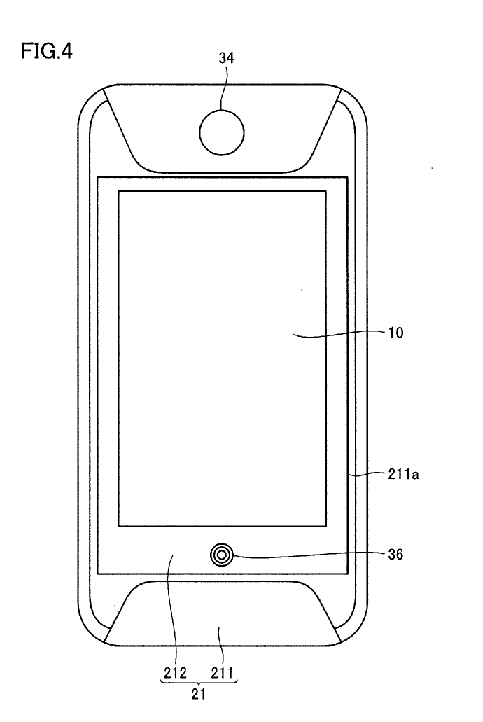

FIG. 4 shows a state with lid portion 32 and the battery having been removed. Rear case member 21 includes an outer member 211 and an inner member 212. The outer member includes an opening 211a. Accommodation portion 10 is seen through opening 211a. Accommodation portion 10 is a recess located in inner member 211 for accommodation of the battery. In FIG. 4, a screw reception hole 36 located in rear case member 21 is seen. Screw reception hole 36 is a hole in which screw 35 (see FIG. 3) is introduced.

FIG. 5 shows rear case member 21 in FIG. 4 taken out alone, the rear case member being disassembled into outer member 211 and inner member 212. Outer member 211 is made by two-color molding. Screw reception hole 36 is located in inner member 212. Outer member 211 includes an opening 34a for the image pick-up portion. Inner member 212 includes an opening 34b for the image pick-up portion. In FIG. 5, accommodation portion 10 located in inner member 212 can clearly be seen.

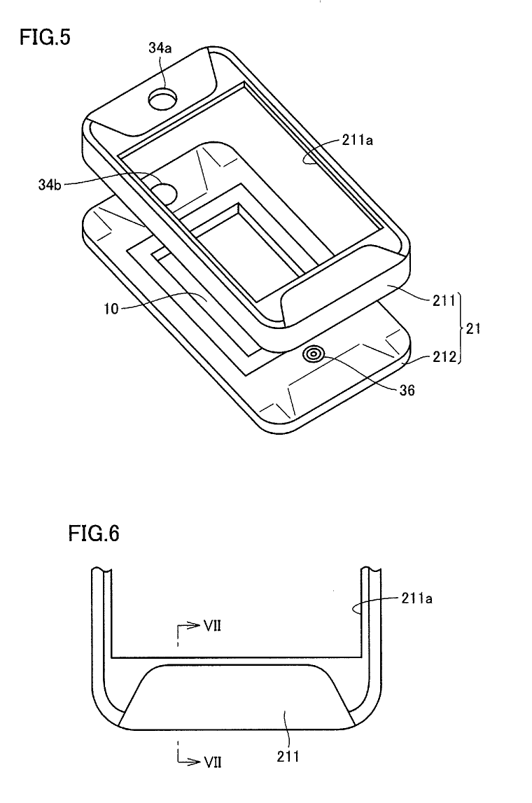

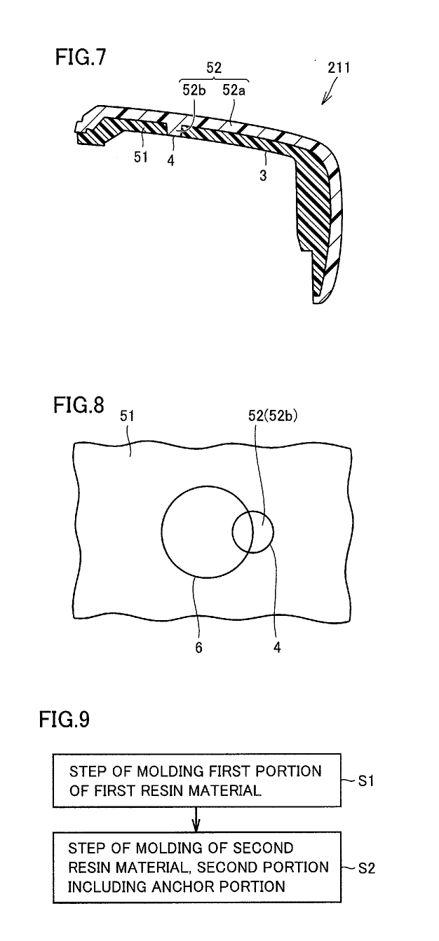

FIG. 6 shows outer member 211 in FIG. 5 taken out alone, with a part thereof being shown in a plan view. FIG. 7 shows a cross-sectional view along the line VII-VII in FIG. 6. FIG. 8 shows the vicinity of an extension portion exposure region 4 in FIG. 7 viewed from below in the figure.

Electronic device 101 includes outer member 211 as a molded component including a first surface 3. First surface 3 is a surface on a back side of outer member 211. The first surface is not necessarily a completely flat surface. As shown in FIG. 7, this molded component includes a first portion 51 comprising a first resin material and a second portion 52 comprising a second resin material. First portion 51 and second portion 52 are integrated by two-color molding. Second portion 52 includes a second portion main body 52a located opposite to first surface 3 and an extension portion 52b which passes through first portion 51 from second portion main body 52a and extends to reach first surface 3. Extension portion 52b may be an anchor portion for reliably fixing second portion 52 to first portion 51. Extension portion 52b includes extension portion exposure region 4 which is exposed as being surrounded by first portion 51 in first surface 3. As shown in FIG. 8, this molded component includes a first line in first surface 3 which is formed by using a mold. At least a part of the first line passes through the inside of extension portion exposure region 4.

In the first embodiment, the first line formed by using a mold is located in first surface 3 of the molded component and a part of the first line passes through the inside of extension portion exposure region 4. Therefore, gas produced in a mold in a process of two-color molding can escape to the outside of the mold through extension portion 52b and further through the first line. Therefore, electronic device 101 in the first embodiment can prevent an appearance from deteriorating due to the gas confined during molding. According to the first embodiment, the appearance of the electronic device can thus be improved.

The first line may define a first geometric shape 6 by surrounding a certain region in first surface 3. By adopting this construction, the first line can readily be located at a desired position.

The first line may be a trace of a boundary line between members of a mold. In the first embodiment, the molded component includes first geometric shape 6 formed as a trace of a boundary line between members of the mold in first surface 3. The line defining first geometric shape 6 corresponds to the first line. At least a part of the line defining first geometric shape 6 passes through the inside of extension portion exposure region 4.

In the example shown in the first embodiment, second portion main body 52a defines an outer surface of outer member 211 as shown in FIG. 7 and the outer surface of outer member 211 defines the appearance of rear case member 21 as shown in FIGS. 4 to 5. Second portion main body 52a defines at least a part of the appearance of electronic device 101. Second portion main body 52a may be a portion directly touched with a hand when a user uses electronic device 101. As shown in the first embodiment, second portion main body 52a may define at least a part of the appearance of electronic device 101. By adopting this construction, deterioration of the appearance due to the confined gas can be prevented in second portion main body 52a and therefore the appearance of electronic device 101 can be satisfactory.

Outer member 211 is described by way of example of the molded component including the first surface in the first embodiment. Outer member 211 is a part of rear case member 21. Rear case member 21 is a part of case member 20 as a housing of electronic device 101. As shown in the first embodiment, the molded component may be at least a part of the housing. By adopting this construction, the appearance of the housing can be satisfactory and hence an impression of the appearance of electronic device 101 can be satisfactory.

In the first embodiment, extension portion exposure region 4 and first geometric shape 6 which appear on first surface 3 as the molded component are shown in FIG. 8. First geometric shape 6 is formed as a trace of the boundary line between the members of the mold as described above. The boundary line between the members may be a boundary line between a mold main body and an ejector pin. Therefore, first geometric shape 6 may be, for example, a trace of the ejector pin. As shown in the first embodiment, first geometric shape 6 is preferably a trace of the ejector pin. By adopting this construction, first geometric shape 6 can readily be formed by using the ejector pin which is an existing structure. The ejector pin refers to a pin incorporated in a mold for taking out a molded product from the mold by pushing.

The first resin material is preferably higher in softening temperature than the second resin material. By adopting this feature, two-color molding can smoothly be performed. The “softening temperature” is also referred to as a “softening point.”

### Second Embodiment

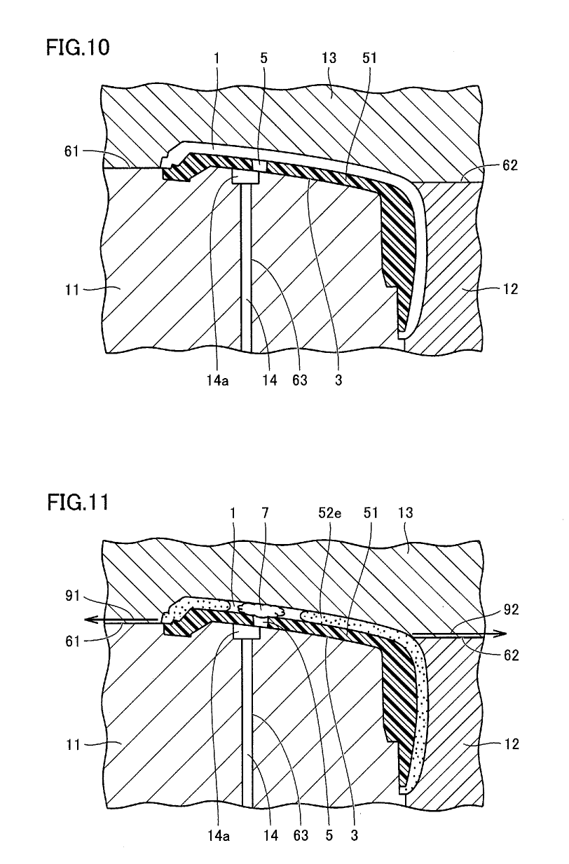

A method of manufacturing an electronic device in a second embodiment based on the present disclosure will be described with reference to FIGS. 9 to 14. FIG. 9 shows a flowchart of the method of manufacturing an electronic device in the second embodiment. FIGS. 10 to 14 show steps.

The method of manufacturing an electronic device in the second embodiment is a method of manufacturing an electronic device including a molded component including first surface 3, and includes a step S1 as a first step of molding first portion 51 from a first resin material, first portion 51 including a through hole 5 which reaches first surface 3 as primary molding of two-color molding and a step S2 as a second step of molding second portion 52 from a second resin material, second portion 52 including second portion main body 52a adjacent to a side opposite to first surface 3 of first portion 51 and extension portion 52b located in through hole 5 and exposed at first surface 3 as secondary molding of two-color molding. In step S2, a mold in contact with first surface 3 is located such that at least a part of a boundary line resulting from combination of separate members passes through the inside of an exposure region in through hole 5 at first surface 3.

Each step will be described in further detail below. General two-color molding includes two steps of primary molding and secondary molding. The method of manufacturing an electronic device in the second embodiment includes a two-color molding step. In order to perform the method of manufacturing an electronic device in the second embodiment, initially, primary molding of two-color molding is performed. Step S1 is a primary molding step. First portion 51 is thus molded. First portion 51 includes first surface 3 and includes through hole 5 which reaches first surface 3. First portion 51 is molded of the first resin material. FIG. 10 shows a state at a time point of completion of molding of first portion 51 and preparation of a mold for secondary molding. A core mold 11, a slide mold 12, and a cavity mold 13 are combined. Core mold 11 was used also in primary molding and it is still used. First portion 51 maintains its position without being removed from core mold 11 used in primary molding. Slide mold 12 and cavity mold 13 are newly combined for secondary molding.

As shown in FIG. 10, first surface 3 of first portion 51 is in intimate contact with core mold 11. At this time point, a void 1 in which a resin for secondary molding is to be introduced is located in the mold. An ejector pin 14 includes an ejector pin head 14a. Ejector pin head 14a abuts on first surface 3 of first portion 51. An upper surface of ejector pin head 14a is flush with an upper surface of core mold 11. An interface where core mold 11 and cavity mold 13 are in contact with each other defines a gap 61. An interface where slide mold 12 and cavity mold 13 are in contact with each other defines a gap 62. An interface where core mold 11 and ejector pin 14 are in contact with each other defines a gap 63. A part of gap 63 is exposed at a bottom surface of through hole 5. Gaps 61, 62, and 63 are small gaps between members which apparently seem to be in intimate contact with each other.

Then, secondary molding of two-color molding is performed. Step S2 is a secondary molding step. FIGS. 11 to 13 show step S2. In step S2, second portion 52 including second portion main body 52a adjacent to the side opposite to first surface 3 of first portion 51 and extension portion 52b which buries through hole 5 and is exposed at first surface 3 is molded of the second resin material. In FIG. 11, a second resin material 52e is injected into the mold through an inlet (not shown) which leads to void 1 from the outside of the mold. In FIG. 11, a space in the mold is successively filled with second resin material 52e from left and right ends and void 1 still remains in the center. Second resin material 52e has not yet been cured. Gas 7 is schematically shown in void 1. Though gas 7 is generated also at left and right ends, the gas generated in the vicinity of the left end escapes through gap 61 as shown with an arrow 91. The gas generated in the vicinity of the right end escapes through gap 62 as shown with an arrow 92. Since the center of the space where second resin material 52e is molded is far from both of gaps 61 and 62, the gas cannot escape through gaps 61 and 62 but tends to stay in void 1 as shown in FIG. 11. In the second embodiment, the gas is as shown in FIG. 12. With decrease in remaining space in void 1 with progress of filling with second resin material 52e, the gas escapes through gap 63 exposed at the bottom surface of through hole 5. The gas escapes through gap 63 as shown with an arrow 93. FIG. 12 shows a state immediately before void 1 is completely filled with second resin material 52e. Though ejector pin 14 is shown as including ejector pin head 14a increased in diameter at an end portion, such ejector pin 14a increased in diameter may be optional. The gas can escape along gap 63 between ejector pin 14 and core mold 11.

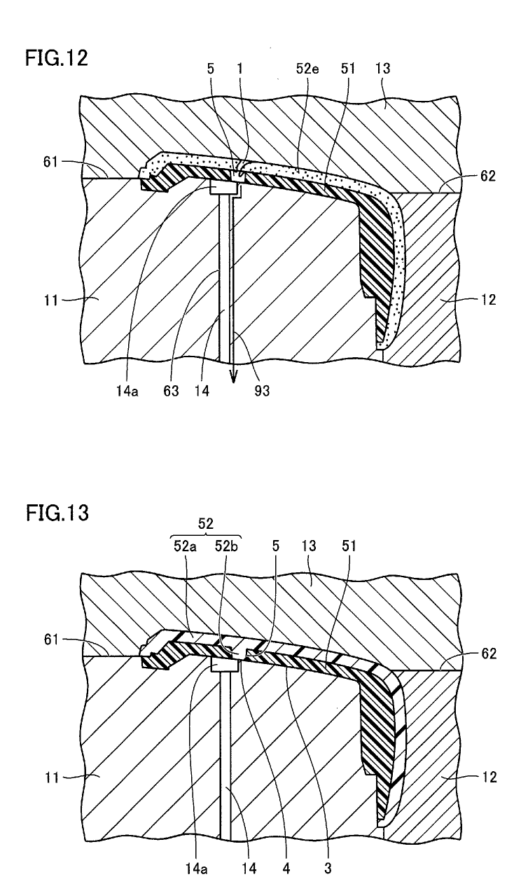

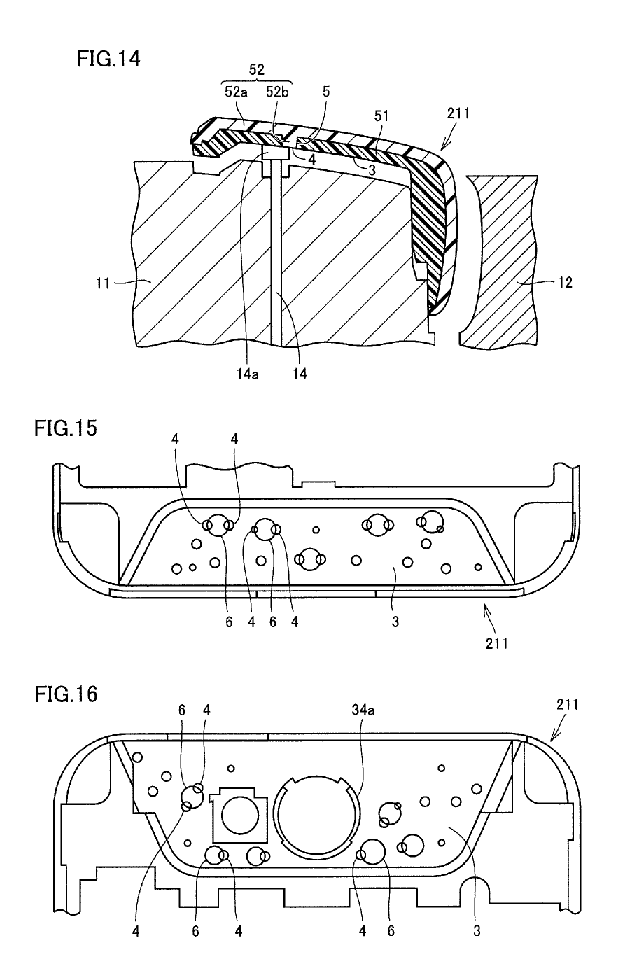

As shown in FIG. 13, the space which remains in the mold is completely filled with second resin material 52e. Substantially the whole gas has escaped and substantially no gas remains in the mold. In this state, second resin material 52e is cured to be second portion 52. Cavity mold 13 is removed, slide mold 12 is separated, and ejector pin 14 is lifted as shown in FIG. 14. Outer member 211 as the molded component is thus pushed up by ejector pin head 14a and moved away from core mold 11. Outer member 211 as the molded component can thus be taken out alone. Outer member 211 is a product obtained by integrating first portion 51 and second portion 52 through two-color molding.

In the second embodiment, in performing step S2, the mold in contact with first surface 3 is located such that at least a part of the boundary line resulting from combination of separate members passes through the inside of the exposure region in through hole 5 at first surface 3. Therefore, gas generated in the mold can escape to the outside of the mold along the gap created at the boundary line. The gap created at the boundary line refers, for example, to gap 63 between ejector pin 14 and core mold 11. Since the gas generated in the mold can thus escape to the outside of the mold, deterioration in appearance of the molded component due to the gas confined during molding can be prevented. Since an electronic device is manufactured with such a molded component, deterioration of the appearance of the electronic device can be prevented.

In the method of manufacturing an electronic device in the second embodiment, second portion main body 52a preferably defines at least a part of the appearance of the electronic device.

In the method of manufacturing an electronic device in the second embodiment, the molded component is preferably a part of the housing.

In the method of manufacturing an electronic device in the second embodiment, preferably, the mold in contact with first surface 3 includes a mold main body and ejector pin 14 which is located to pass through the mold main body and can protrude from the mold main body, and the boundary line defines a border between the mold main body and the ejector pin.

In the method of manufacturing an electronic device in the second embodiment, preferably, the first resin material is higher in softening temperature than the second resin material. By adopting this feature, two-color molding can smoothly be performed.

FIGS. 15 and 16 show a part of outer member 211 included in electronic device 101 in the first embodiment as being enlarged. This corresponds to the molded component made with the method of manufacturing an electronic device in the second embodiment. FIG. 15 corresponds to a lower end portion when outer member 211 shown in FIG. 15 is taken out alone and turned over. FIG. 16 similarly corresponds to an upper end portion. FIGS. 15 and 16 both correspond to a state that a back surface, that is, first surface 3, of outer member 211 is seen. As shown in FIGS. 15 and 16, a large number of extension portion exposure regions 4 and first geometric shapes 6 are located in first surface 3. In the example, extension portion exposure region 4 is seen as a small circle, first geometric shape 6 is seen as a large circle, and they overlap with each other. One first geometric shape 6 and one extension portion exposure region 4 overlap with each other in some cases, and one first geometric shape 6 overlap with a plurality of extension portion exposure regions 4 in other cases. Attention should be paid to the feature that at least a part of a line defining first geometric shape 6 passes through the inside of extension portion exposure region 4.

Some of the large number of extension portion exposure regions 4 may not overlap with first geometric shape 6. In the example shown in FIGS. 15 and 16, all of several first geometric shapes 6 overlap with one or more extension portion exposure regions 4, however, some of first geometric shapes 6 do not have to overlap with extension portion exposure region 4.

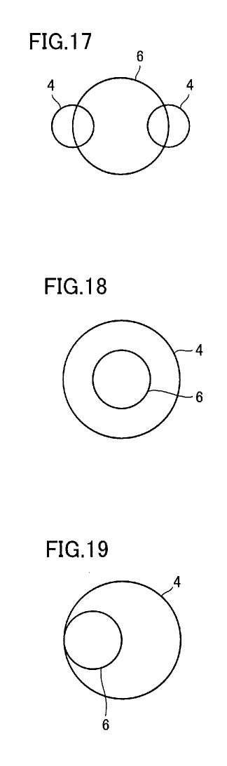

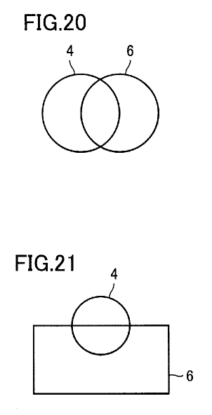

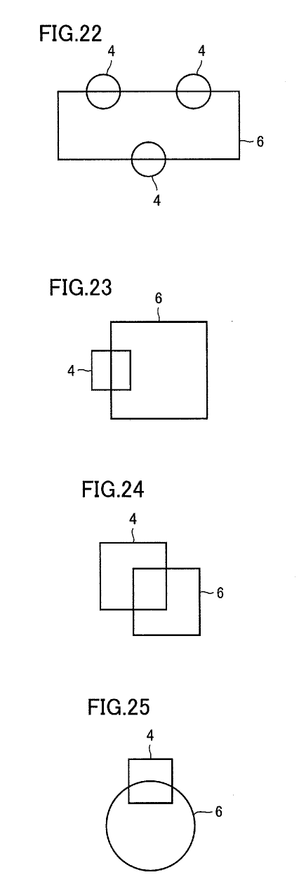

A typical combination between extension portion exposure region 4 and first geometric shape 6 shown in FIGS. 15 and 16 is as shown in FIG. 17. One first geometric shape 6 overlaps with two extension portion exposure regions 4. At least a part of the line defining first geometric shape 6 should only pass through the inside of extension portion exposure region 4. For example, as shown in FIG. 18, the entire first geometric shape 6 may completely be located inside one extension portion exposure region 4. Though first geometric shape 6 and extension portion exposure region 4 are concentric in the example shown in FIG. 18, limitation to being concentric is not intended. As shown in FIG. 19, first geometric shape 6 may be inscribed in extension portion exposure region 4. First geometric shape 6 may be displaced further toward the left to intersect with the circle defined by extension portion exposure region 4. As shown in FIG. 20, first geometric shape 6 and extension portion exposure region 4 may be substantially equal in size. A shape of extension portion exposure region 4 and first geometric shape 6 is not limited to a circle. As shown in FIGS. 21 and 22, at least one of extension portion exposure region 4 and first geometric shape 6 may be in a shape other than a circle, for example, rectangular. In an example shown in FIG. 22, one rectangular first geometric shape 6 overlaps with a plurality of extension portion exposure regions 4. Since there is a point in that at least a part of the line defining first geometric shape 6 passes through the inside of extension portion exposure region 4, each extension portion exposure region 4 is located to lie across a contour line of first geometric shape 6.

A shape of extension portion exposure region 4 which appears at first surface 3 is not limited to a circle either and other shapes may be applicable. For example, examples as shown in FIGS. 23, 24, and 25 are also applicable.

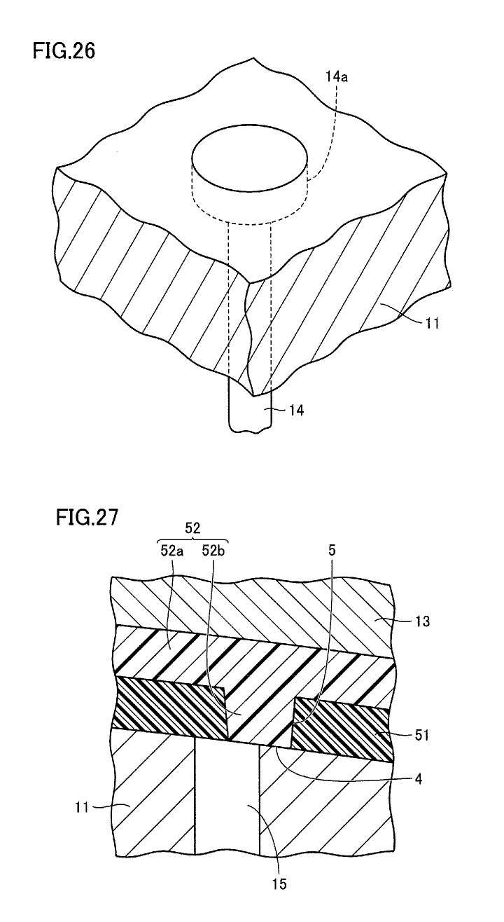

FIG. 26 shows a perspective view of one example of a construction in which ejector pin 14 including ejector pin head 14a is located as being surrounded by core mold 11.

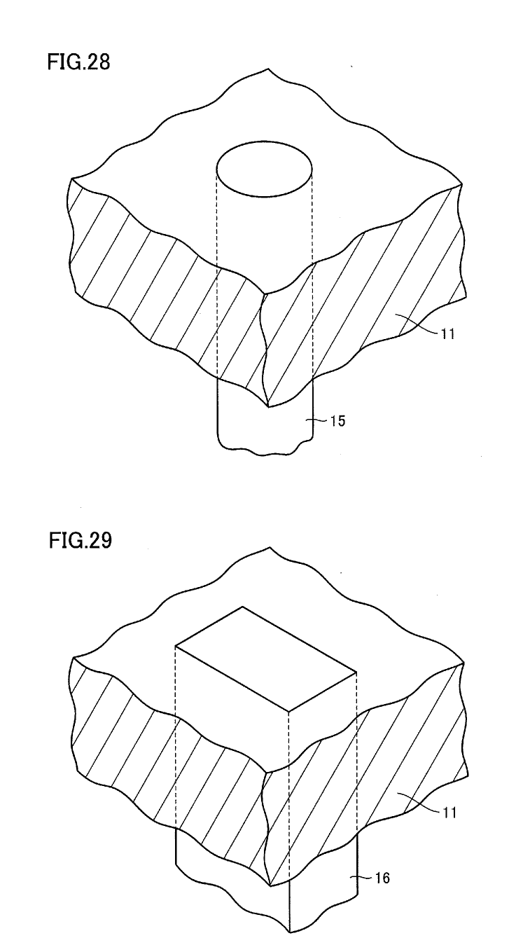

Though an example in which a contour line of ejector pin 14 located as being surrounded by core mold 11 defines first geometric shape 6 is described as the premise so far, a pin 15 which is not an ejector pin may be located as being surrounded by core mold 11 as shown in FIG. 27. FIG. 28 shows a perspective view of the vicinity of pin 15 in this case. Pin 15 may be a pin irrelevant to a role of pushing a product out of a mold. Pin 15 may be a member which includes no movable mechanism. Though pin 15 shown here is columnar, a member in a shape other than a column may be applicable. For example, in an example shown in FIG. 29, a block 16 in a shape of a quadrangular prism is located.

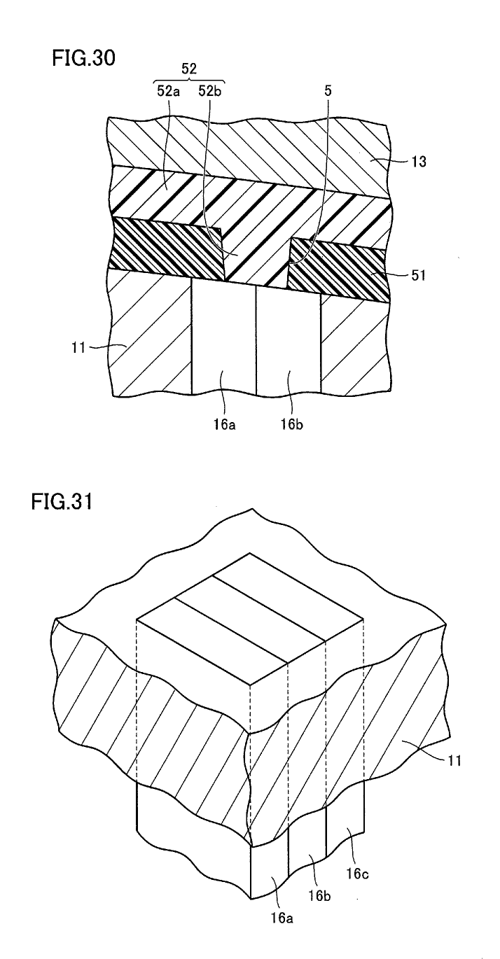

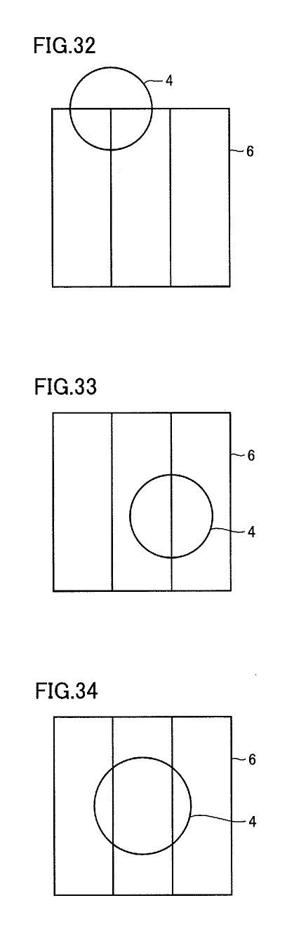

A member such as a pin or a block located in core mold 11 is not limited to one member, and a plurality of members may be located as shown in FIG. 30. In an example shown in FIG. 30, two blocks 16a and 16b are located as being combined. As shown in FIG. 31, three blocks 16a, 16b, and 16c may be located as being combined. When three blocks 16a, 16b, and 16c each in a shape of a quadrangular prism are located in core mold 11 as shown in FIG. 31, first geometric shape 6 is in a shape as shown in FIG. 32. FIG. 32 shows one example of positional relation of extension portion exposure region 4. FIGS. 33 and 34 show other examples. In this case as well, at least a part of the line defining first geometric shape 6 passes through the inside of extension portion exposure region 4.

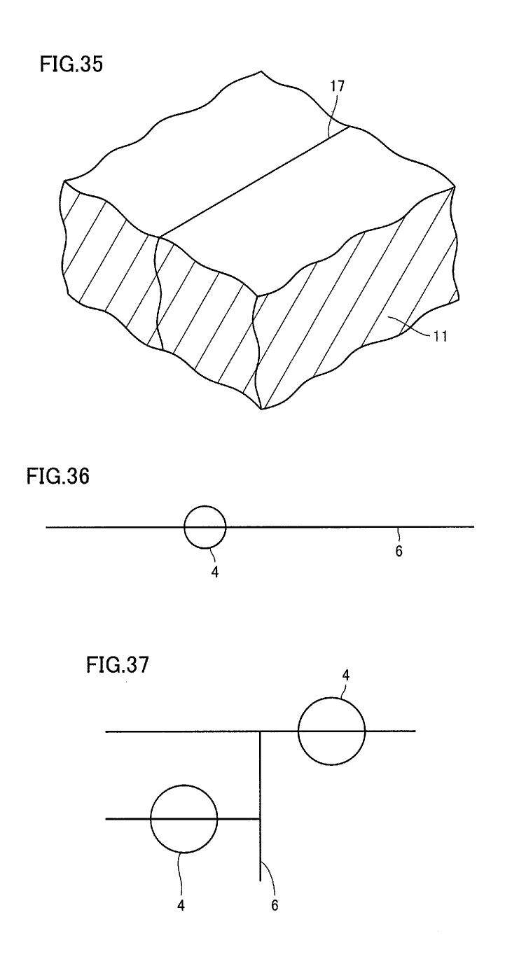

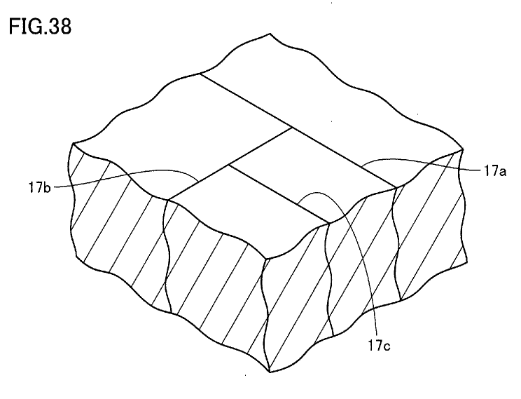

Though an example in which a separate member (an ejector pin, a pin, and a block) is located in core mold 11 and an end surface thereof is exposed so that a boundary line between members of a mold defines first geometric shape 6 as a trace on first surface 3 has been described so far, limitation as such is not intended. A mold itself may be constituted of a plurality of members, and a boundary line therebetween may define first geometric shape 6 as a trace on first surface 3. For example, when a boundary line 17 is located in core mold 11 as shown in FIG. 35, first geometric shape 6 may be linear as shown in FIG. 36. The first geometric shape is not limited to a geometric shape in a closed shape such as a circle, a quadrangle, or a polygon, and may be a simple straight line as such. The first geometric shape is not limited to a straight line but may be a curve or a bent line. In the examples shown in FIGS. 35 and 36 as well, at least a part of the line defining first geometric shape 6 passes through the inside of extension portion exposure region 4. First geometric shape 6 is not limited to one straight line, and for example, any group of a plurality of straight lines is applicable as shown in FIG. 37. In the example shown in FIG. 37 as well, at least a part of the line defining first geometric shape 6 passes through the inside of extension portion exposure region 4. In order to form first geometric shape 6 as shown in FIG. 37, a mold should only be constituted of a plurality of members as being combined as shown in FIG. 38. In FIG. 38, boundary lines 17a, 17b, and 17c are formed by combination of a plurality of members for realizing a mold.

Attention has been paid to the feature that outer member 211 is made of a molded component, with case member 20 being present as a part of electronic device 101, rear case member 21 being present as a part of case member 20, and outer member 211 being present as a part of rear case member 21, and a surface on the back side of the molded component is described as first surface 3 so far. This is merely by way of example and a structure of the electronic device is not limited as such. Even when an electronic device includes a case member, a structure of the case member is not limited to the structure as described so far.

A molded component to which attention is to be paid may be some kind of a member included in an electronic device. The molded component is preferably a component which defines at least a part of an appearance of the electronic device. The component which defines at least a part of the appearance is not limited to a housing, and it may be, for example, a button used for some kind of operation or some kind of a cover.

A plurality of additional features in embodiments above may be adopted as being combined as appropriate.

Though description has been given so far by using the term “electronic device,” the electronic device is a broad concept covering, for example, a portable telephone, a portable information terminal, a tablet terminal, a personal computer, a game console, a television receiver, a portable music player, a CD player, a DVD player, an electronic dictionary, an electronic book reader, a digital camera, a video camera, a radio receiver, and a navigation system. The concept of the portable telephone or the portable information terminal includes a smartphone.

Embodiments disclosed herein are illustrative and non-restrictive in every respect. The scope of the present disclosure is defined by the terms of the claims and is intended to include any modifications within the scope and meaning equivalent to the terms of the claims.

### REFERENCE SIGNS LIST

1 void; 3 first surface; 4 extension portion exposure region; 5 through hole; 6 first geometric shape; 7 gas; 11 core mold; 12 slide mold; 13 cavity mold; 14 ejector pin; 14a ejector pin head; 15 pin; 16, 16a, 16b, 16c block; 17, 17a, 17b, 17c boundary line; 20 case member; 21 rear case member; 22 front case member; 31 display area; 32 lid portion; 34 image pick-up portion; 34a, 34b opening; 35 screw; 51 first portion; 52 second portion; 52a second portion main body; 52b extension portion; 52e second resin material; 61, 62, 63 gap; 91, 92, 93 arrow; 101 electronic device; 211 outer member; 212 inner member; and 211a opening

1. An electronic device comprising a molded component including a first surface,
the molded component including a first portion comprising a first resin material and a second portion comprising a second resin material, the second portion including an exposure region in the first surface as at least a part of the second portion being embedded in the first portion,
the molded component including a first line in the first surface, and
at least a part of the first line passing through inside of the exposure region.

2. The electronic device according to claim 1, wherein
the first line defines a first geometric shape by surrounding a certain region in the first surface.

3. The electronic device according to claim 1, wherein
the first line is a trace of a boundary line between members of a mold.

4. The electronic device according to claim 1, wherein
the first portion includes a through hole which starts from the first surface, and
the second portion includes an extension portion located in the through hole and a main body which defines at least a part of an appearance of the electronic device.

5. The electronic device according to claim 1, wherein
the molded component is at least a part of a housing.

6. The electronic device according to claim 1, wherein
the first line is a trace of an ejector pin.

7. The electronic device according to claim 1, wherein
the first resin material is higher in softening temperature than the second resin material.

8. A method of manufacturing an electronic device including a molded component including a first surface, the method comprising:
a first step of molding a first portion from a first resin material, the first portion including a through hole which reaches the first surface; and
a second step of molding a second portion from a second resin material, the second portion including an extension portion located in the through hole and exposed at the first surface,
in the second step, a mold in contact with the first surface being located such that at least a part of a boundary line resulting from combination of different members passes through inside of an exposure region in the through hole at the first surface.

9. The method of manufacturing an electronic device according to claim 8, wherein
the second portion includes a main body and the main body defines at least a part of an appearance of the electronic device.

10. The method of manufacturing an electronic device according to claim 8, wherein
the molded component is at least a part of a housing.

11. The method of manufacturing an electronic device according to claim 8, wherein
the mold in contact with the first surface includes a mold main body and an ejector pin which is located to pass through the mold main body and can protrude from the mold main body, and
the boundary line defines a border between the mold main body and the ejector pin.

12. The method of manufacturing an electronic device according to claim 8, wherein
the first resin material is higher in softening temperature than the second resin material.
